(19) United States
(12) Patent Application Publication
(10) Pub. No.: US 2018/0332883 A1
(43) Pub. Date: Nov. 22, 2018

(54) Thickened Powdered Food Product

(71) Applicant: Kellogg Company, Battle Creek, MI (US)

(72) Inventor: Olufunmilayo R. Ekundayo, Battle Creek, MI (US)

(21) Appl. No.: 15/986,543

(22) Filed: May 22, 2018

Related U.S. Application Data
(60) Provisional application No. 62/509,407, filed on May 22, 2017.

(51) Int. Cl. A23P 10/47; A23L 19/00; A23L 11/00; A23L 2/39

(52) U.S. Cl. CPC A23P 10/47; A23L 19/01; A23V 2002/00; A23L 2/39; A23L 11/07

(57) ABSTRACT

The present disclosure provides for a powdered food composition that can be reconstituted into a creamy, yogurt-like, or smoothie-style food having optional inclusions and that delivers the taste, organoleptic characteristics, mouthfeel, and nutritional benefits of conventional ready-to-eat cereal products. In one approach, the food composition or powdered food composition includes a powder component and a non-powder component. The powder component is capable of being quickly reconstituted or hydrated with water or other fluid to a creamy consistency and within a very short amount of time with little to no shear other than hand mixing with a spoon or other utensil.

### CROSS REFERENCE TO RELATED APPLICATIONS

This application claims priority under 35 U.S.C. § 119(e) to U.S. Provisional Application 62/509,407, filed on May 22, 2017. The disclosure of this prior application is considered part of the disclosure of this application and is hereby incorporated by reference in its entirety.

### FIELD

The present disclosure relates generally to powdered food products and, more particularly, to powdered food products with inclusions that can be reconstituted into a thickened cereal, creamy yogurt, or smoothie-style food.

### BACKGROUND

There is growing consumer demand for highly convenient breakfast foods that deliver both high taste and nutritional benefits. On the go lifestyles, such as those eating away from home or eating at work during the typical breakfast meal time, make ready-to-serve options very appealing. Additional desired benefits include ease of preparation, lack of mess, and easy clean-up when done eating.

Delivering great taste attributes is often associated with time consuming preparation steps such as cutting, mixing, blending and possibly cooking to deliver the right balance of desirable flavor and texture experiences. Many separate ingredients, carefully measured, are often needed to deliver the desired end experience and organoleptic characteristics. These can include fruit pieces, nuts, clusters, protein powder, added flavor, or farinaceous materials to suggest but a few examples.

In many cases, there is often competition between the many ingredients of cereal-type foods for the absorption of water leading to uneven hydration, off character texture, or lack of flavor diffusion. Fruit pieces that are too hard or nut or cluster pieces that are too soft would be typical hydration-related issues and often undesired for the consumer. An additional problem can be a rapid over hydration leading to sogginess and undesirable soft, mushy textures which is often typical of prior reconstituted cereals

To mimic the ready-to-eat, creamy yogurt-style and dairy-type smoothie products, it would be advantageous to have a creamy, dairy like consistency instantly without the actual need for added dairy components that would require refrigeration. Consumers often prefer the ability to mix and coat their food items with a flavorful, creamy base material. This provides a heightened sensory experience. The ability of a breakfast food to quickly achieve the desired creamy texture with, in some instances, minimal effort, without the need of added dairy components, and/or with an extended time where the food retains its desirable taste attributes is highly desirable.

A powdered material that can be reconstituted is often preferred for convenience. However, a problem attempting to mimic ready-to-eat mixed creamy and crunchy foods using consumer-reconstituted powdered materials, in some instances, is that the needed level of an added liquid, such as water, to achieve an instant desirable, creamy texture can be difficult to ascertain while maintaining the crunchy aspects of added inclusions at the same time. There is a tradeoff where the amount of liquid is very important to the end result, but the amount to add is not readily apparent. This can lead to a trial and error approach by the consumer that is not consistent with the desire for convenient, high taste breakfast foods. It would be advantageous to have a liquid addition approach and product that consistently and easily delivers the right level to deliver target attributes of creamy and crunchy textures at the same time.

In other instances, typical powdered beverages prepared with milk or water can be very thin and not mimic the creamy textures of typical yogurt-style and smoothie-type foods. On the other hand, too much milk or water can lead to soggy inclusions that are intended to remain crunchy or have a firm bite. To achieve creamy thickness, hydrocolloids and other thickeners are often used to achieve this texture characteristic. However, when hydrocolloids and other thickeners are added to powdered products that also include powdered dairy ingredients, these thickening ingredients can, in some instances, bind with calcium ions in the milk and form aggregates or an insoluble materials. This shortcoming is often heightened in a powdered composition when little to no heat or shear is added for mixing. As a result, there is no intended thickening or there can be coagulation because there is often acid containing ingredients that may not interact favorably with the dairy ingredients.

### SUMMARY

In one aspect, a food composition configured for reconstitution by a fluid into a creamy food is provided by this disclosure. In one aspect, the food composition includes a powder component including thickener, protein blends, optional dairy powders, and a thickener powder blend selected from a fruit powder, a vegetable powder, and/or a grain powder, and mixtures thereof. The food composition also includes a non-powder component including one or more of clusters, toasted ingredients, puffed or popped ingredients, flakes, nuts, fruit pieces, seed, and mixtures thereof. The thickener powder blend is provided in an amount and with one or more of a particle size distribution, a water absorption index value, and/or a dynamic water absorption rate effective to instantly thicken the consistency of the food composition into a thick and creamy food and wherein the non-powder component exhibits a solid, crunchy, and/or firm texture associated with its included components.

In other approaches, the food composition of the previous paragraph may be combined with one or more options features either individually or in various compositions as needed for a particular application. For example, the food composition may also include: wherein the powder component includes a select water absorption index value effective to achieve the creamy consistency of the reconstituted food; and/or wherein the water adsorption index is about 0.5 to about 2 grams of water absorption; and/or wherein the water adsorption index is about 2 to about 3.5 grams of water absorption; and/or wherein the water absorption index is about 2 to about 4 grams of water absorption; and/or wherein the select water absorption index is obtained from a combination of one or more high water absorbing ingredients, medium water absorbing ingredients, low water absorbing ingredients, and combinations thereof in the powder component; and/or wherein the high water absorbing ingredients, the medium water absorbing ingredients, and the low water absorbing ingredients are selected from dried pear powder, soy protein isolate, cry cranberry powder, beet powder, apple powder, mango powder, pear powder, banana powder, carrengeenan powder, strawberry powder, strawberry almond quinoa powder, mango coconut powder, sunflower powder, blueberry powder, and mixtures thereof; and/or wherein the high water absorbing ingredients are selected from soy protein isolate powder, pear powder, banana powder, apple powder, mango powder, cranberry powder, blueberry powder and mixtures thereof; and/or wherein the high water absorbing ingredients absorb about 2.7 to about 4 grams of water in about 12 to about 20 seconds; and/or wherein the medium water absorbing ingredients are selected from carrageenan, mango coconut powder, strawberry powder, sunflower powder, and mixtures thereof; and/or wherein the medium water absorbing ingredients absorb about 2.2 to about 2.6 grams of water in about 12 to about 20 seconds; and/or wherein the low water absorption ingredients are the remaining powder ingredients in the composition; and/or wherein the low water absorption ingredients absorb less than about 2.2 grams of water in about 12 to about 20 seconds; and/or wherein the powder component includes a select dynamic water absorption rate effective to instantly thicken the consistency of the food composition/and/or wherein the dynamic water absorption rate is about 0.5 to about 2 grams of water absorption in about 2 to about 7 seconds; and/or wherein the dynamic water absorption rate is about 2 to about 3.5 grams of water absorption in about 7 to about 12 seconds; and/or wherein the dynamic water absorption rate is about 2 to about 4 grams of water absorption in about 12 to about 15 seconds; and/or wherein the select dynamic water absorption rate is obtained from a combination of one or more of the high water absorbing ingredients, medium water absorbing ingredients, low water absorbing ingredients, and combinations thereof in the powder component; and/or wherein the powder component is selected from dried pear powder, soy protein isolate, cry cranberry powder, beet powder, apple powder, mango powder, pear powder, banana powder, carrengeenan powder, strawberry powder, strawberry almond quinoa powder, mango coconut powder, sunflower powder, blueberry powder, and mixtures thereof.

In another aspect, the disclosure provides for a kit including a receptacle having a fluid indication line and further including the powder composition above. In yet another aspect, the disclosure provides for a method of reconstituting the powder composition as described above to form a creamy consistency while maintaining a crunchy texture of the non-powder component.

### BRIEF DESCRIPTION OF DRAWING FIGURES

FIG.1 is graph of ingredient viscosity by starch paste cell method;

FIG. 2 is a graph of storage modulus of various ingredients;

FIG. 3 is a graph of finished product viscosity;

FIG. 4 is a graph of coefficient of friction; and

FIG. 5 is a graph of water update of various ingredients.

### DETAILED DESCRIPTION

The present disclosure provides for a powdered food composition that can be reconstituted into a creamy, yogurt-like, or smoothie-style food having optional inclusions and that delivers the taste, organoleptic characteristics, mouthfeel, and nutritional benefits of conventional ready-to-eat cereal products. In one approach, the food composition or powdered food composition includes a powder component and a non-powder component. The powder component is capable of being quickly reconstituted or hydrated with water or other fluid to a creamy consistency and within a very short amount of time with little to no shear other than hand mixing with a spoon or other utensil. The non-powder component is preferably in the form of crunchy-type inclusions, fruit pieces, vegetable pieces, flakes, nuts, combinations thereof, and the like that remain crunchy, firm, and/or non-soggy in the final creamy and reconstituted food.

In one aspect, the powder component includes effective amounts and ratios of low water absorbing powders, medium water absorbing powders, and/or high water absorbing powders as measured via water absorption index or WAI. In some instances, these powders include a blend of one or more of fruit, vegetable, and/or grain powders combined with powdered thickener ingredient(s), powdered protein ingredient(s), and optional powdered dairy or creamer ingredient(s) in select ratios of the high, medium, and/or low water absorption powders to achieve the creamy textures when the powder component is reconstituted. These powders, in some approaches, may also have select dynamic water absorption rates that are effective so that the powder component (or at least portions thereof) rapidly hydrates to achieve the desired textural endpoint. This powder component, which is believed to be due at least in part to the select blend of the high, medium, and/or low water absorbing powders with the associated rapid absorption rates thereof, is able to achieve the desired creamy consistency, texture, and viscosity in the hydrated or reconstituted food typically found in ready-to-eat cereals that require refrigeration. While not wishing to be limited by theory, it is believed that the select fruit, vegetable, and/or grain powders herein may aid in achieving a balance of equilibrium water absorption and dynamic absorption rates to effectively hydrate the powder component quickly relative to the non-powder component. Thus, the powder component hydrates while the non-powder component retains its crunchiness, firmness, and/or bite depending on the inclusions therein.

In another aspect, the non-powder component may be in the form of added inclusions, such as nuts, nut pieces, toasted inclusions, puffed or popped ingredients, clusters, flakes, agglomerates, seeds, fruit pieces, vegetable pieces, other like additives, and mixtures thereof. These inclusions remain crunchy, firm, and/or non-soggy upon reconstitution. The specifically tailored powder component mentioned above including the fruit/vegetable/grain thickener powder (and with the other powdered ingredients) is designed to hydrate quickly and automatically to the desired, relatively stable texture end point without causing the inclusions to hydrate to a soggy or non-crunchy state. If included, the inclusions would be added as single entities or as a blended ad-mix such that their physical property specifications for the rate and diffusion of water absorption within pieces enable them to hydrate, if needed, to a desired water activity level and crunchy texture end point. The water activity of the various components in the non-powder component of the mixture are, individually or in combination, from about 0.1 to about 0.5.

Optionally, the compositions herein may also include nutrients that promote health, well-being, and personal energy. For instance, these inclusions may include, but not be limited to vitamins, minerals, protein sources, pre or probiotics, and mixtures thereof. A frequent problem with the addition of nutrients to breakfast foods is the presence of uncharacteristic, unpleasant flavors or after tastes. There is often the tradeoff where the level of added nutrient needed to deliver efficacy does not taste good. This subsequently leads to a non-optimum usage level of too little to be effective or a poor taste experience. The selection and tailoring of the added total food ingredient and nutrient mix to deliver the desired nutritional efficacy while also maintaining a desirable organoleptic characteristics and positive flavor experience is achieved herein.

The compositions herein, in some approaches, provide a complete breakfast meal or meal kit that delivers a hand holdable, on-the-go package sized food composition to fit easily within a backpack, purse or briefcase that provides a controlled method for adding the correct amount of liquid to the breakfast mix material where the breakfast mix instantly develops a creamy consistency, provides a desired taste experiences, and is capable of added nutrition benefits.

Turning to more of the specifics, the food composition may be a dry mix including the powder component and the non-powder component that is hydrated or reconstituted as a combined mass into a creamy, yogurt-like, or smoothie-type food having crunchy inclusions (or if other fruit or vegetable inclusions, the desired firm texture or bite for such food type). The food composition is configured so that the powder component has priority for hydration and hydrates into the creamy portion quickly while the non-powder component remains crunchy, firm, or hydrates to the desired water activity, texture, or bite associated with the inclusion (meaning not soggy, etc.). While not wishing to be limited by theory, it is believed that such priority for hydration may be due to the selected ratios of the high, medium, and/or low water absorption ingredients and their associated dynamic water absorption rates in the powder component of the food composition.

In one approach, the powder component may include thickener, proteins, optional creamer (dairy or non-dairy), and the selected fruit, vegetable, and/or grain thickening powders. This powder component may have a selected water absorption index and selected dynamic water absorption rates in view of the blended of powders therein. To this end, the powder component may have selected individual ingredients with select water absorption index values and/or select dynamic water absorption rates to aid in achieving the blended absorption values and rates of the combined powder. Composition and particle size of the powders may also aid in water absorption and hydration rates.

The powdered component may also include other powders such as vegetable powders, cocoa powders, coffee powder, roast and ground coffee, other flavors and seasonings, and the like, and mixtures thereof as needed for particular applications. The powder component may further include fibrous or farinaceous ingredients or components. If included, the food composition may include about 0 to about 10 weight percent of the other powders (individually or combined, such as vegetable powder or cocoa powders, or coffee powders and the like) and about 0.1 to about 7.4 weight percent of flavors and seasonings.

As mentioned above, the powder component may include a select water absorption index and/or a select dynamic water absorption rate effective to achieve a peak viscosity or pasting upon reconstitution to achieve a creamy texture while retaining the desired crunchy and/or non-soggy textures of the non-powdered inclusions. The select water absorption index values and dynamic water absorption rates of the powder component blends or individual ingredients therein may be based upon the particle size, surface area, composition (i.e., starch, fiber, protein, etc.) and the like and may be factors associated with the final organoleptic characteristics of the product, such as taste, mouthfeel, texture, and the like. Thus (and without wishing to be limited by theory), it is believed that the select water absorption index and dynamic water absorption rates may be effective to achieve desired sensory and organoleptic characteristics that are associated with a high degree of liking by consumers. It was also recognized that a creamy, thick texture and mouthfeel upon reconstitution may be associated with consumers with a desired ready-to-eat cereal. Thus, in some approaches, it may also be effective that Instron and/or viscosity values (to suggest a few characteristics that may be related to texture and mouthfeel) of the reconstituted food may be an important parameter to achieve consumer acceptance.

As used herein, viscosity is a measurement of the consistency of a fluid or slurry and the foods herein may be measured for viscosity upon reconstitution with a fluid or water. Viscosity reflects the resistance of a force tending to cause the fluid or slurry (i.e., reconstituted powders) to flow. Viscosity may be measured using a Brookfield viscometer HB5 and may be one parameter associated with mouthfeel and consumer liking herein.

As also used herein, an RVA or a rapid visco analyzer or analysis is a measurement of the general pasting profiles for flour or starch. RVA may be measured using AACC International method 76-21.01. Pasting profiles may be another parameter associated with the texture and mouthfeel of consumer liking.

As further used herein, Water absorption Index or WAI is a measurement of the water absorption capacity of an ingredient or blend of ingredients. In some aspects, this index is a measurement of the solvent retention capacity or SRC of the ingredients or blend of ingredients. AACC International method 56-11.02 may be used to measure solvent retention capacity profile or the water absorption capacity of ingredients of blends thereof. WAI may reflect the unique ability of the powder components herein to quickly hydrate to a creamy texture over the non-powdered components. The powder component may have blends of high, medium, and/or low WAI ingredients.

More specifically, the fruit, vegetable, and/or grain powders of the powder component may be in the form of a powder or particulate blend and may be dried or micro-dried fruits, freeze dried fruits, flash frozen fruits, or powders derived from fruit purees and the like. These powders may also include a vegetable powder or a gain powder or may be a blend of powdered or particulate fruits, vegetables, and/or grains or any combination thereof. By one approach, the food composition (that is, both the powdered and non-powdered components prior to hydration) may include about 0 to about 10 weight percent of the fruit/vegetable/grain thickening powder (either individually or in combination). In other approaches, the food composition prior to hydration may include about 1 to about 18 weight percent and, in other approaches, about 2 to about 6 weight percent of the total fruit/vegetable/grain thickening powder either individually or in combinations thereof. The fruit/vegetable/grain powder may be provided in an amount and with a particle size distribution effective, when reconstituted or hydrated with a fluid, to manage fluid hydration by instantly thickening and prioritizing the moisture migration so that the powdered component hydrates first (over the non-powdered component) into a thick and creamy food with little to no shear. Exemplary individual fruit and/or vegetable powders may include about 1 to about 3 percent of spinach powder, about 1 to about 3 percent of green tea powder, about 1 to about 5 percent strawberry powder, about 1 to about 3 percent of cranberry powder, about 0.1 to about 1 percent of beet powder, about 1 to about 4 weight percent mango powder, and about 2 to about 8 percent pear or apple powder (in other approaches, about 3 to about 8 percent pear or apple powder), and combinations thereof. In some approaches, the fruit and or vegetables may be freeze dried and/or freeze dried powdered fruit and vegetables.

In one approach, the fruit/vegetable/grain thickening powder may pass through a 20 to 80 mesh screen. In other approach, dried pear may be a versatile powder for the thickener, but other fruits, vegetables, and grains may function as well. In general, the particular composition of the fruit/vegetable/grain thickening powder is selected to match the flavor needs of the resultant food.

Without wishing to be limited by theory, the fruit/vegetable/grain powder ingredient of the powder component may aid in building viscosity without sliminess or gelling. Flavor delivery is bright and evenly dispersed. The food composition remains stable during storage before consumer use. If larger fruit, vegetable, or grain pieces were used instead of the fruit/vegetable/grain thickening powder, the hydration benefits discovered herein would generally not be possible.

The powder component may also include hydrocolloids, pre-gelatinized grain starches, additional fruit powders and extracts, seed powders and extracts, and mixtures and various combinations thereof. One suitable thickener may be carrageenan and/or pre-gelatinized grain starches. In one approach, the food composition before hydration may include about 0.2 to about 5.5 weight percent of thickener ingredients, and in other approaches, about 0.2 to about 4.7 weight percent thickener ingredients. For instance, the food composition may include about 0.2 to about 1 weight percent of carrageenan (in other approaches, about 0.2 to less than about 1 weight percent) and about 0 to about 4.5 weight percent pre-gelatinized grains (in other approaches, about 0 to about 3.8 weight percent) as additional thickener ingredients.

The protein portion of the powder component may include a protein blend of plant proteins, animal proteins, or mixtures thereof. Examples of a protein powder may be, but not limited to, whey, soy, pea, rice, wheat, oat, casein, corn, amaranth, quinoa, and the like, and mixtures thereof. In some approaches, a suitable protein powder may be soy protein isolate and the composition may include about 1 to about 5 weight percent soy protein isolate powder. By one approach, the food composition before hydration may include about 14 to about 32 weight percent total protein ingredients, and in other approaches, about 16 to about 28 weight percent protein.

The creamer portion of the powder component may include non-fat dry milk powder, dairy protein powder, carbohydrates powders from dairy sources, dairy fats and oils, and derivatives thereof. The food composition may include about 1 to about 4 weight percent of creamer powder ingredients, and in other approaches, about 2 to about 3 weight percent. If a non-dairy creamer is used, it may be about 1 to about 4 percent of the composition.

As mentioned, the food composition may also include a non-powder component. In one approach, the non-powder component may include clusters, toasted inclusions, puffed or popped inclusions, flakes, nuts, seeds, larger fruit pieces, and the like and mixtures thereof. In one approach, the cluster ingredients of the non-powder component may include, but is not limited to, clustered, shredded and extruded pieces of soy, oat wheat, corn, spelt, rice, ray, wheat, wild rice, tricale, barley, sorghum, millet, or mixtures thereof. If included, the food composition may include about 14 to about 23 weight percent cluster ingredient.

The toasted inclusions of the non-powder component may include toasted rice, oat, wheat, quinoa, sorghum, corn, millet, or mixtures thereof. If included, the food composition may include about 8 to about 27 weight percent of the toasted ingredient.

The puffed or popped ingredient of the non-powder component may include wheat, amaranth, quinoa, sorghum, corn, millet, or combinations thereof. If used, the food ingredient may include about 0 to about 9 weight percent of the puffed or popped ingredient.

The flaked ingredients of the non-powder component may include flakes of sorghum, rice, corn, wheat, or mixtures thereof. If used, the food component may include about 0 to about 14 weight percent of flaked ingredients.

The nut ingredient of the non-powder component may include tree nuts, soy nuts, edible seeds, fruit nuts, or mixtures thereof. If included, the food component may include about 0 to about 28 weight percent of nut ingredients.

The non-powdered component of the food composition may also include optional seeds. The seed ingredient of the non-powder component may include chia, flax, seas am, sunflower, pepitas, or mixtures thereof. If included, the food composition may include about 0 to about 5 weight percent of seed ingredients.

The non-powder component may also include non-powdered or larger fruit pieces. If such pieces are included in the food composition, the food composition may include about 0 to about 17 weight percent of non-powdered or fruit ingredients.

In addition to the powder component and the optional, non-powder component, the food composition may also include other optional components or ingredients. For example, the food composition may also may further include a sweetener, such as but not limited to, sugar, sugar syrups, high intensity sweeteners, fruits, fruit syrups, and additional fruit powders. In one approach, the food composition may include about 1 to about 12 weight percent sweetener. The composition may also include tocopherol powder, such as about 0.05 to about 0.2 weight percent.

Other optional ingredients include flavors and seasonings, such as but not limited to, natural flavors and seasonings, extracts and flavors with other natural flavors (WONFs), other natural flavor types and artificial flavors, sweet and/or savory seasonings, salt, spices, other like ingredients, and mixtures thereof Optional additives may also include noodles and chocolate pieces. As mentioned above, the optional flavors, seasonings, and the like may account for about 0.1 to about 8 weight percent of the food composition.

In one approach, the powdered food composition includes about 40 to about 75 weight percent of the non-powder components and about 30 to about 60 weight percent of the powder components. A typical serving size of the reconstituted food may be about 54 to about 66 grams with about 54 to about 77 grams of water per serving. In other approaches, a select ratio of the powdered food composition to reconstitution fluid may be about 60 grams of the powdered food composition to about 60 to about 70 grams of water. In some approaches, the percentage of food ingredients in the total composition (that is food ingredients and water) may be about 40 to about 60 weight percent and the percentage of water in the total combination (that is food and water) is about 50 to about 60 water. In the total combination, the percentage of thickener may be about 0.2 to about 5 weight percent.

Other exemplary ranges are found in Table 1 below

TABLE 1
Exemplary Ranges

| | | Broad | Narrower |
|---|---|---|---|
| | | Ranges, | Ranges, |
| Ingredients | | wt % | wt % |
| Non- | Clusters | 14 to 25 | 15 to 21 |
| Powder | Toasted | 8 to 27 | 9 to 25 |
| Component | Puffed/Popped | 0 to 9 | 0 to 8 |
| | Flaked | 0 to 14 | 0 to 12 |
| | Nut | 0 to 28 | 0 to 25 |
| | Fruit | 0 to 17 | 0 to 15 |
| | Other Inclusions | 0 to 11 | 0 to 11 |
| Powder | Seed (Chia) | 0 to 5 | 0 to 3.8 |
| Component | Thickener | 0.1 to 1.0 | 0.2 to 0.9 |
| | (Carrageenan) | | |
| | Thickener | 0 to 4.5 | 0 to 3.8 |
| | (pre-gelatinized | | |
| | Grain) | | |
| | Protein | 14 to 32 | 16 to 29 |
| | Creamer | 1 to 4 | 2 to 3.0 |
| | Fruit powder | 0 to 10 | 0 to 9 |
| | Other powder, | 0 to 8 | 0 to 7 |
| | veggie, cocoa, | | |
| | etc. | | |
| | Flavors, | 0.1 to 7.5 | 0.2 to 6.7 |
| | seasonings, | | |
| | Sweetener | 1.5 to 12 | 2 to 10.6 |

The food competition is configured to be reconstituted or hydrated with a liquid to produce a creamy food having crunchy, firm, or non-soggy inclusions therein. The hydration fluid may be water (hot or cold), juices, non-dairy creamer, coffee, cocktails, alcohol, dairy liquids cream, and mixtures thereof.

As used herein, the term “taste” generally means an overall consumer acceptance of a food as a result of the combination of the food's organoleptic properties, mouthfeel, and appearance. The term “organoleptic” generally includes the flavor, texture, mouthfeel, smell, and/or sound of a food that are experienced by the consumer of the food when eaten. The phrase “relative taste” or “relative organoleptic score” generally refers to a difference between a sample mean overall taste score of a test product as reported by a panel of trained tasters and the sample mean overall taste score of a reference. In general, the quality of a consumer's eating experience and, thus the effectiveness of a food achieving a desired organoleptic quality (such as duplicating a ready-to-eat creamy food), may be dependent on the food's overall organoleptic properties and visual appeal, which in turn may be dependent on the food's composition, structure, texture, mouthfeel, and/or, in some instances, processing. Although a food's taste qualities may include organoleptic properties and visual appeal, taste, texture, and/or mouthfeel may be generally related to a high consumer liking of a food. These properties may be related to viscosity, pasting level, and Instron performance.

In one approach, the powdered food composition is provided in a container and lid combination or kit. The container includes the powdered food composition including the powder component, the non-powder component, and other optional ingredients. The lid may include a fluid fill line that provides an example of a controlled water addition feature. Thus, in use, a consumer may remove the lid, add the desired amount of fluid up to the fill line in the lid and, then add the fluid to the container with the food composition. Upon low shear mixing (such as hand mixing with a spoon or other common kitchen utensil), the select fluid amount combined with the ratios of the powder to non-powder component as well as the included powders enable to powder component to instantly or quickly hydrate into a creamy yogurt or smoothie-style food while the non-powder ingredients remain crunchy, firm, and/or non-soggy. The lid may include an optional collapsible spoon or other mixing element detachably mounted therein. Thus, in use, a consumer detaches the spoon form the lid, adds fluid to the fill line in the lid, adds the fluid to the container with the powdered food composition and mixes with the un-collapsed spoon to achieve the desired consistency. The spoon may then be used to consume the reconstituted food.

A better understanding of the present disclosure and its many advantages may be clarified with the following examples. The following examples are illustrative and not limiting thereof in either scope or spirit. Those skilled in the art will readily understand that variations of the components, methods, steps, and devices described in these examples can be used. Unless noted otherwise or apparent from the context of discussion, all percentages, ratios, and parts noted in the Examples and elsewhere in this disclosure are by weight.

### EXAMPLES

In the Examples herein, the following equipment and methods were utilized. Test instrument 1 was an ARES G2 rotational rheometer with a 25 mm CH PP plate, a 2 mm gap, and oil applied. The method used for this testing was to first soak the samples at ambient temperature (about 70° F.) for 2 minutes and then run a stain sweep from 0.1 to 1% at 1 Hz. Also, the same sample was also used to run a state sensing flow sweep from 0.001 to 0.1 l/s with max time of 3 minutes (3 pt/dec). Test instrument 2 was an AR2000ex rheometer with a starch paste cell. For this testing, soak time of the samples was 0 and peak hold was 1 (l/s) for 10 minutes. Test instrument 3 was a Brookfield HA viscometer with vane V75 using a shear ramp at each speed for 30 seconds.

### Example 1

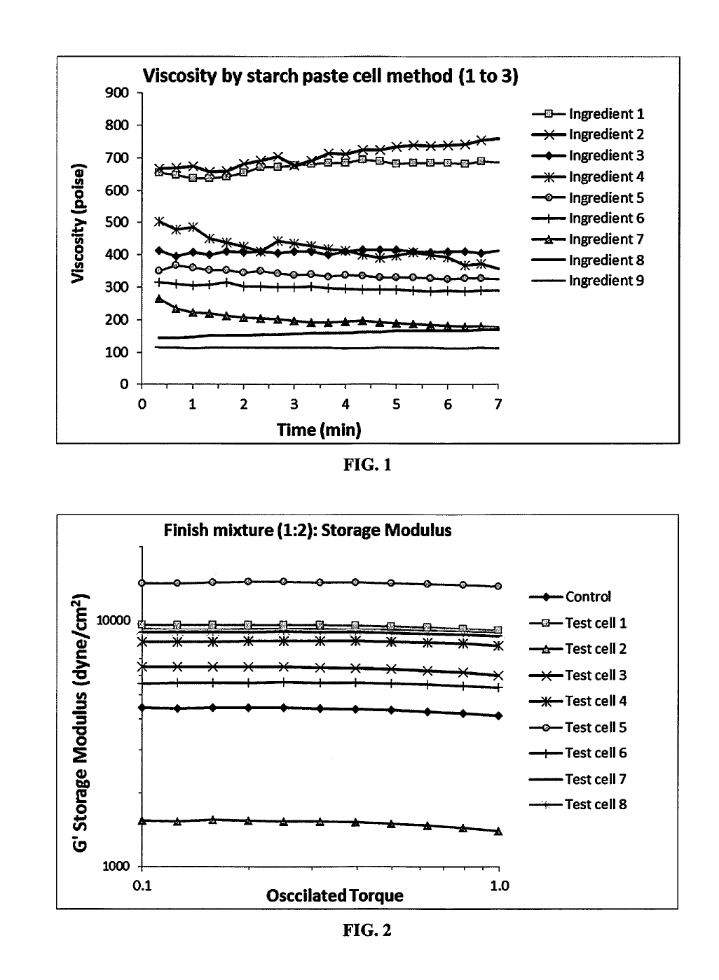

To evaluate the hydration properties of various ingredients, the viscosity of the tested ingredients in water (1 part of ingredient in 3 parts of distilled water) at ambient temperature was determined by using the rheometer of test instrument 2 with a starch pasting cell which is equivalent to RVA (starch pasting cell). Sample preparation involved about 12 grams of the ingredient powder blended in about 24 ml of DI water, hand mixing for 30 seconds, and then holding for about 5 minutes before testing. Based on this testing, it was clear that the ingredients with different water holding capacities resulting in a wide range of viscosity of the slurries. For this examples, the ingredients of Table 1 were tested and the results are shown in FIG. 1.

TABLE 1
Powder Ingredients tested

| | |
|---|---|
| Ingredient 1 | Dried Pear |
| Ingredient 2 | Micro Dry Cranberry |
| Ingredient 3 | Van Bruner Strawberries |
| Ingredient 4 | Beet Powder |
| Ingredient 5 | LM Apple |
| Ingredient 6 | Chancel strawberry |
| Ingredient 7 | Isolated soy protein powder |
| | (Supro XT 2210) |
| Ingredient 8 | Van Bruner Banana powder |
| Ingredient 9 | Mango Powder |

As shown in FIG. 1, viscosity from the starch pasting methods range from about 100 to about 800 poise with the tested ingredients. In other approaches, about 100 to about 500 poise, in other approaches, about 100 to about 300 poise, and in yet other approaches, about 600 to about 800 poise. This viscosity was obtained within 1 to 7 seconds of testing and, in some approaches, about 1 to 3 second.

### Example 2

To fine-tune the mouthfeel of a thickened powdered food product, the samples (1 part of blend in 2 parts of distilled water) with the ingredients having different hydration properties were tested for the stiffness (storage modulus). A rheometer with parallel plates was utilized for the test at ambient temperature. This Exampled showed that it was possible to modify the consistency of the blends by using the ingredients with different levels of viscosity and hydration properties. For this Example, the compositions of Table 2 were evaluated and the results are shown in FIG. 2.

TABLE 2

| Sample ID | Ingredient 1 | Ingredient 2 |
|---|---|---|
| Test Cell 1 | 1.5 grams of soy protein | 0.12 grams of |
| (control) | isolate powder (Supro | carrageenan powder |
| | 221) | (Ticloid 750) |
| Test Cell 2 (High | 1.5 grams of soy protein | 0.24 grams of TIC |
| carrageenan) | isolate powder | 750 |
| Test Cell 3 (No | 1.5 grams soy protein | — |
| carrageenan) | isolate powder | |
| Test Cell 4 (Low | 0.9 grams of cold-swelling | — |
| corn starch) | corn starch powder | |
| | (Novation 5600) | |
| Test Cell 5 (Mid | 1.8 grams of cold-swelling | — |
| corn starch) | corn starch powder | |
| Test Cell 6 (High | 2.7 grams of cold-swelling | — |
| corn starch) | corn starch powder | |
| Test Cell 7 (low | 1.0 grams of cold swelling | — |
| rice starch) | rice starch powder | |
| | (Pen pure) | |
| Test Cell 8 (Mid | 2.0 grams of cold swelling | — |
| rice starch) | rice starch powder | |
| Test Cell 9 (High | 3.0 grams of cold swelling | — |
| rice starch) | rice starch powder | |

### Example 3

To correlate the sensory evaluation, the viscosity of multiple flavored thickened powered food samples were tested for viscosity using a rheometer with starch pasting cell at ambient temperature. Depending on the formulations, they showed slightly different viscosity profiles. Some of them showed a continuous increase in viscosity upon mixing whereas the other showed shear thinning behavior. Results are shown in FIG. 3.

### Example 4

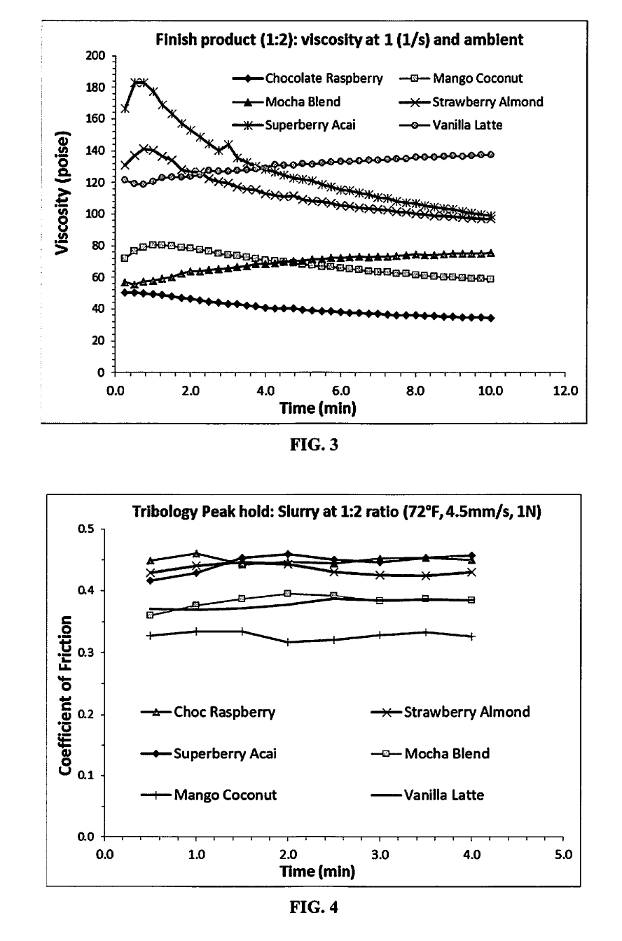

To provide further insights as to mouthfeel, the multiple thickened powdered samples were tested for coefficient of friction by a tribology test accessory on a rheometer. There was no significant difference in the friction coefficient suggesting that the difference in creaminess and grittiness would be minimal. Results are shown in the graph of FIG. 4.

### Example 5

Particle size analysis was also completed on the samples from Examples 3 and 4. Particle size analysis was done by laser diffraction and showed that the multiple thickened powdered samples had comparable particle size distributions. Results are shown in the Table Below. Particle size for a surface weight mean is about 60 to about 110, a volume weight mean is about 190 to about 285 with D10 ranging from about 25 to about 60, a D50 ranging from about 155 to about 200, and a D90 ranging from about 385 to about 480 as shown from the ranges in the Table below.

TABLE 3
Particle Size

| | Surface | Volume | | | |
|---|---|---|---|---|---|
| | wt mean | wt mean | | | |
| Sample Name | D[3, 2] | D[4, 3] | d(0.1) | d(0.5) | d(0.9) |
| Mocha Blend | 62.0 | 193.9 | 27.5 | 157.2 | 414.5 |
| Chocolate Raspberry | 72.0 | 214.6 | 33.4 | 167.1 | 468.0 |
| Strawberry Almond | 70.2 | 202.6 | 32.9 | 168.8 | 422.5 |
| Superberry Acia | 108.4 | 237.4 | 58.5 | 191.4 | 478.0 |
| Vanilla Latte | 100.3 | 285.9 | 53.8 | 194.6 | 669.2 |
| Mango Coconut | 78.4 | 194.7 | 38.9 | 161.0 | 389.9 |

### Example 6

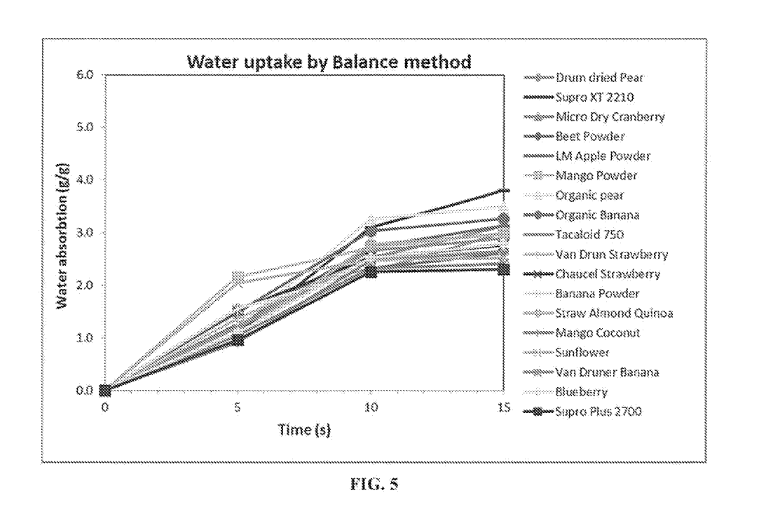

Water absorption was analyzed for various ingredients. Testing was completed in a water absorption device using the following procedure: (1) Fill water in the device's reservoir on the balance, let the water equilibrate on both reservoir, and then record the initial wt. (2) Tap 0.5 grams of the test sample on a paper through a 30 or 40 mesh screen sieve to let the sample evenly spread on the filter paper. (3) Record the sample wt (0.5 g), and place the paper and sample on a foam, and immediately start collect increase in weight. Water absorption data is shown in the Graph of FIG. 5. As shown, water absorption at about 5 seconds ranged from about 0.5 to about 2 grams of water absorption, at 10 second about 2 to about 3.5 grams of water absorption, and about 15 seconds about 2 to about 4 grams of water absorption. These dynamic water absorption rates by ingredient type are as described above in the Summary Section.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element, layer, ingredient, component is referred to as being “on,” “engaged to,” “connected to,” “attached to,” or “coupled to” another element, layer, ingredient, component it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1 to 4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure. Unless otherwise noted, all weights, ratios, and percentages are by weight.

What is claimed is:

1. A food composition configured for reconstitution by a fluid into a creamy food, the food composition including:
a powder component including thickener, protein blends, optional dairy powders, and a thickener powder blend selected from a fruit powder, a vegetable powder, and/or a grain powder, and mixtures thereof;
a non-powder component including one or more of clusters, toasted ingredients, puffed or popped ingredients, flakes, nuts, fruit pieces, seed, and mixtures thereof; and
wherein the thickener powder blend is provided in an amount and with one or more of a particle size distribution, a water absorption index value, and/or a dynamic water absorption rate effective to instantly thicken the consistency of the food composition into a thick and creamy food and wherein the non-powder component exhibits a solid, crunchy, and/or firm texture associated with its included components.

2. The food composition of claim 1, wherein the powder component includes a select water absorption index value effective to achieve the creamy consistency of the reconstituted food.

3. The food composition of claim 1, wherein the water absorption index is about 0.5 to about 2 grams of water absorption.

4. The food composition of claim 3, wherein the water absorption index is about 2 to about 3.5 grams of water absorption.

5. The food composition of claim 4, wherein the water absorption index is about 2 to about 4 grams of water absorption.

6. The food composition of claim 2, wherein the select water absorption index is obtained from a combination of one or more high water absorbing ingredients, medium water absorbing ingredients, low water absorbing ingredients, and combinations thereof in the powder component.

7. The food composition of claim 6, wherein the high water absorbing ingredients, the medium water absorbing ingredients, and the low water absorbing ingredients are selected from dried pear powder, soy protein isolate, cry cranberry powder, beet powder, apple powder, mango powder, pear powder, banana powder, carrengeenan powder, strawberry powder, strawberry almond quinoa powder, mango coconut powder, sunflower powder, blueberry powder, and mixtures thereof.

8. The food composition of claim 6, wherein the high water absorbing ingredients are selected from soy protein isolate powder, pear powder, banana powder, apple powder, mango powder, cranberry powder, blueberry powder and mixtures thereof.

9. The food composition of claim 8, wherein the high water absorbing ingredient absorb about 2.7 to about 4 grams of water in about 12 to about 20 second.

10. The food composition of claim 6, wherein the medium water absorbing ingredients are selected from carrageenan, mango coconut powder, strawberry powder, sunflower powder, and mixtures thereof.

11. The food composition of claim 10, wherein the medium water absorbing ingredients absorb about 2.2 to about 2.6 grams of water in about 12 to about 20 seconds.

12. The food composition of claim 1, wherein the powder component includes a select dynamic water absorption rate effective to instantly thicken the consistency of the food composition.

13. The food composition of claim 12, wherein the dynamic water absorption rate is about 0.5 to about 2 grams of water absorption in about 2 to about 7 seconds.

14. The food composition of claim 13, wherein the dynamic water absorption rate is about 2 to about 3.5 grams of water absorption in about 7 to about 12 seconds.

15. The food composition of claim 14, wherein the dynamic water absorption rate is about 2 to about 4 grams of water absorption in about 12 to about 15 seconds.

16. The food composition of claim 12, wherein the select dynamic water absorption rate is obtained from a combination of one or more of the high water absorbing ingredients, medium water absorbing ingredients, low water absorbing ingredients, and combinations thereof in the powder component.

17. The food composition of claim 12, wherein the powder component is selected from dried pear powder, soy protein isolate, cry cranberry powder, beet powder, apple powder, mango powder, pear powder, banana powder, carrengeenan powder, strawberry powder, strawberry almond quinoa powder, mango coconut powder, sunflower powder, blueberry powder, and mixtures thereof.
